(19) United States
(12) Patent Application Publication
(10) Pub. No.: US 2008/0239136 A1
(43) Pub. Date: Oct. 2, 2008

(54) Focal Length Detecting For Image Capture Device

(76) Inventors: Kunihiko Kanai, Nagano (JP); Minoru Yajima, Nagano (JP)

Correspondence Address: EASTMAN KODAK COMPANY;PATENT LEGAL STAFF, 343 STATE STREET, ROCHESTER, NY, 14650-2201, US

(21) Appl. No.: 10/586,783

(22) PCT Filed: Apr. 26, 2005
(86) PCT No.: PCT/US05/14219

§ 371 Date: Jul. 21, 2006

(30) Foreign Application Priority Data
Apr. 26, 2004 (JP) 2004-129918

(51) Int. Cl. H04N 5/225; H04N 5/232

(52) U.S. Cl. 348/340; 348/345; 348/E05.042; 348/E05.024

(57) ABSTRACT

A device detects focal length using image data and an optical system is driven. Image data are acquired while changing focal length to lens. For each image data, high frequency contrast component evaluated values VH, and low frequency contrast component evaluated values VL, are acquired. If there is no moire, an image focal length D1 is determined using a peak value of the high frequency component evaluated values VH. If there is moire, in a range of high frequency component evaluated values adopting values less than or equal to a reference evaluated value VL2 calculated based on low frequency component evaluated values and photographing conditions, image capture focal lengths Da and Db are determined.

### FIELD OF THE INVENTION

The present invention relates to an image capture focal length detecting method for detecting focal length from image data, and to an image capture device.

### BACKGROUND OF THE INVENTION

In conventional image capture device such as a video camera or an electronic still camera, a lens is focused by extracting high frequency components of captured image data.

With this method of focusing, a picture is taken while driving a lens to move a focal point, and for each lens position high frequency components of the image data are extracted to calculate contrast evaluated values (hereafter called contrast). The lens position is then moved so as to increase the contrast, and the position of maximum contrast is made the lens focused position.

When taking a picture of a subject having high frequency components, such as a fine striped pattern, if frequency components of an image formed on an imaging element at the focused position of the lens exceed a nyquist frequency noise known as moiré occurs in the image, and there may be situations where image quality is degraded. If an optical lowpass filter is used to suppress this moiré, there is a problem that it is difficult to reduce manufacturing cost, and in the event that no moiré occurs the filter will affect image quality.

In this respect, as a structure intended to suppress moiré without using an optical low pass filter, it is known to detect occurrence of moiré, and if moiré occurs move the imaging lens to a position offset from the focused position (refer to patent document 1, for example). Specifically, with this structure, in a state where the lens is moved from the focused position, normally contrast of low frequencies varies only slightly compared to contrast of high frequencies, and occurrence of moire is detected utilizing the fact that contrast of low region frequencies occurring as moire varies similarly to contrast of high frequencies.

If moire is detected, that is, if variation in low region contrast is larger than a predetermined value compared to the variation in high region contrast, the lens is offset from the focused position by moving etc., and moire is suppressed by optically obscuring the image on the imaging element. With this structure, however, detection of moire, that is, movement amount of the lens is only indicated when variation of low region contrast is larger than a predetermined value compared to the high region contrast variation, and there is a problem that it is not always possible to move the lens to an appropriate position depending on the photographing environment.

Also, in order to compensate for positional offset of focal point image surface when changing magnification in a zoom lens, there is known a structure for, when moving a first lens when changing magnification, after forced movement of a second lens such that focus is offset from a focused position, once again moving the second lens in a focusing direction (refer to patent document 2, for example). However, this structure is intended to move a lens within a depth of field, and is not capable of suppressing moire. Patent document 1: Japanese Patent Application No. 3247744 (page 3, FIG. 4). Patent document 2: Japanese Patent Application No. 2795439 (page 3, FIG. 3, FIG. 16(D))

### SUMMARY OF THE INVENTION

As described above, with respect to movement amount of a lens in the event that moire is detected, it is determined using a fixed value and there is a problem that it is not really possible to move the lens to an appropriate position according to photographing environment etc.

The present invention has been conceived in view of this problem, and an object of the present invention is to provide an image capture focal length detecting method that can effectively suppress moire, and to an image capture device.

An image capture focal length detecting method of a first aspect of the invention comprises the steps of acquiring a plurality of image data while varying the focal length of an optical system, acquiring, from the acquired plurality of image data, high frequency component evaluated values, being contrast evaluated values of respective high frequencies, and low frequency component evaluated values, being contrast evaluated values of low frequency components of a frequency lower than the high frequency; calculating a first focal length using whichever image data a peak value of the high frequency component evaluated values is recorded in, detecting whether or not there is a moire in image data of this first focal length, making the first focal length an image capture focal length if there is no moire in the image data of the first focal length, and when there is moire in the image data of the first focal length, comparing reference evaluated values corresponding to a length based on the low frequency component evaluated values with evaluated values corresponding to a length based on the high frequency component evaluated values, and selecting an image capture focal length in a range where this evaluated value takes a value that is less than or equal to the reference evaluated value.

With this structure, when moire is detected a necessary lens movement amount is set according to conditions using high frequency component evaluated values and low frequency component evaluated values, moire is suppresses and imaging is possible with good focus on a subject.

With an image capture focal length detecting method of a second aspect of the invention, calculation of reference evaluation values involves calculation of a proportion of low frequency component evaluated values and high frequency component evaluated values for each image data, for the case when a peak value of low frequency component evaluated values and a peak value of high frequency component evaluated values coincide, and also calculation using a calculation to relatively subtract low frequency component evaluated values from high frequency component evaluated values.

With this structure, amount of lens movement can be easily calculated using high frequency component evaluated values and low frequency component evaluated values.

With an image capture focal length detecting method of a third aspect of the invention, low frequency component evaluated values are relatively subtracted to calculate reference evaluated values, in response to a specified value, being a variable, according to image capture conditions.

With this structure, image capture focal length is calculated in an appropriate range according to image capture conditions.

With an image capture focal length detecting method of a fourth aspect of the invention, the specified value is set larger as the depth of field becomes larger.

With this structure, if the depth of field is large, the specified value is made large and moire is sufficiently suppressed by making the movement amount of the lens large.

On the other hand, if the depth of field is small, the specified value is made small and moire is sufficiently suppressed by making the movement amount of the lens small.

With an image capture focal length detecting method of a fifth aspect of the invention, any focal length where an evaluated value based on a high frequency component evaluated value matches a reference evaluated value is selected as an image capture focal length depending on image capture mode.

With this structure, by selecting image capture focal length according to image capture mode, focal length is detected in line with the photographer's intentions, and an image the photographer intends to take is captured.

With an image capture focal length detecting method of a sixth aspect of the invention, whether or not a moire exists is detected utilizing variation in high frequency component evaluated values and low frequency component evaluated values in a plurality of image data that have been acquired while varying focal length of an optical system.

With this structure, using acquired high frequency component evaluated values and low frequency component evaluated values, detection of moire and setting of lens movement amount are possible, and the structure is simplified.

With an image capture focal length detecting method of a seventh aspect of the invention, a plurality of image detection regions that are adjacent to each other are set, from a plurality of acquired image data, a partial focal length is calculated using whichever image data a peak value of respective contrast evaluated values is recorded in, for every image detection region, and a reliability according to movement of a position where respective peak values are recorded between the plurality of image data is calculated, and in response to the reliability and the evaluated values, a first focal length is selected from among the partial focal lengths and a specified focal length. With this structure, in order to calculate reliability corresponding to movement of between image data of positions where a contrast evaluated peak value is recorded, partial focal lengths for image detection regions where reliability of a subject that has moved relatively is low are removed from objects of selection, and accurate focal length detection becomes possible.

An image capture device of the present invention comprises an imaging element, an optical system for causing an image of a subject to be formed on this imaging element, optical system drive means for varying a focal length of the optical system, and image processing means for processing image data output from the imaging element and controlling the optical system drive means, wherein the image processing means controls the optical system drive means, acquires a plurality of image data while changing focal length of the optical system, acquires, from the acquired plurality of image data, high frequency component evaluated values, being contrast evaluated values of respective high frequencies, and low frequency component evaluated values, being contrast evaluated values of low frequency components of a frequency lower than the high frequency, calculates a first focal length using whichever image data a peak value of the high frequency component evaluated values is recorded in, detects whether or not there is a moire in image data of this first focal length, makes the first focal length an image capture focal length if there is no moire in the image data of the first focal length, and when there is moire in the image data of the first focal length, compares reference evaluated values corresponding to a length based on the low frequency component evaluated values with evaluated values corresponding to a length based on the high frequency component evaluated values, and selects an image capture focal length in a range where this evaluated value takes a value that is less than or equal to the reference evaluated value, and controls the optical system drive means to set focal length of the optical system to the image capture focal length.

With this structure, when moire is detected a necessary lens movement amount is set according to conditions using high frequency component evaluated values and low frequency component evaluated values, moire is suppresses and imaging is possible with good focus on a subject.

According to the present invention, when moire is detected a necessary lens movement amount is set according to conditions by using high frequency component evaluated values and low frequency component evaluated values, moire is suppressed and imaging is possible with good focus on a subject.

### BRIEF DESCRIPTION OF THE DRAWINGS

FIG. 1 is a structural drawing showing one embodiment of an image capture device of the present invention.

FIG. 2 is an explanatory drawing showing an image processing circuit of the image capture device in detail.

FIGS. 3A and 3B are an explanatory drawing showing operation of the image capture device when there is no blurring, with FIG. 3A being an explanatory drawings showing a relationship between a window and the subject, and FIG. 3B being an explanatory drawing showing variation in evaluated values for contrast.

FIG. 4 is an explanatory drawing showing a relationship between a window and the subject when there is blurring with the image capture device.

FIGS. 5A and 5B are an explanatory drawings showing operation of the image capture device when there is blurring, with FIG. 5A being an explanatory drawing showing a relationship between a window and the subject, and FIG. 5B being an explanatory drawing showing variation in evaluated values for contrast for windows W4 and W5.

FIG. 6 is an explanatory drawing showing a relationship between a window and the subject when there is blurring with the image capture device.

FIG. 7 is a flowchart showing operation of the image capture device.

FIG. 8 is a flowchart showing operation of the image capture device.

FIG. 9 is a flowchart showing operation for calculating number of image data acquired in the image capture device.

FIG. 10 is a flowchart showing a weighting operation of the image capture device.

FIG. 11 is a flowchart showing a focal length calculation operation of the image capture device.

FIG. 12 is a flowchart showing a moire processing operation of the image capture device.

FIGS. 13A, 13B and 13C are an explanatory drawings showing a moire processing operation of the image capture device, with FIG. 13A being a state before processing of high frequency component evaluated values and low frequency component evaluated values, FIG. 13B is a state where each evaluated value has been normalized, and FIG. 13C is a state calculated offset amount has been applied.

FIG. 14 is a flowchart showing operation of another embodiment of an image capture device of the present invention.

### DETAILED DESCRIPTION OF THE INVENTION

In the following, one embodiment of an image capture focal length detecting method and an image capture device of the present invention will be described with reference to the drawings.

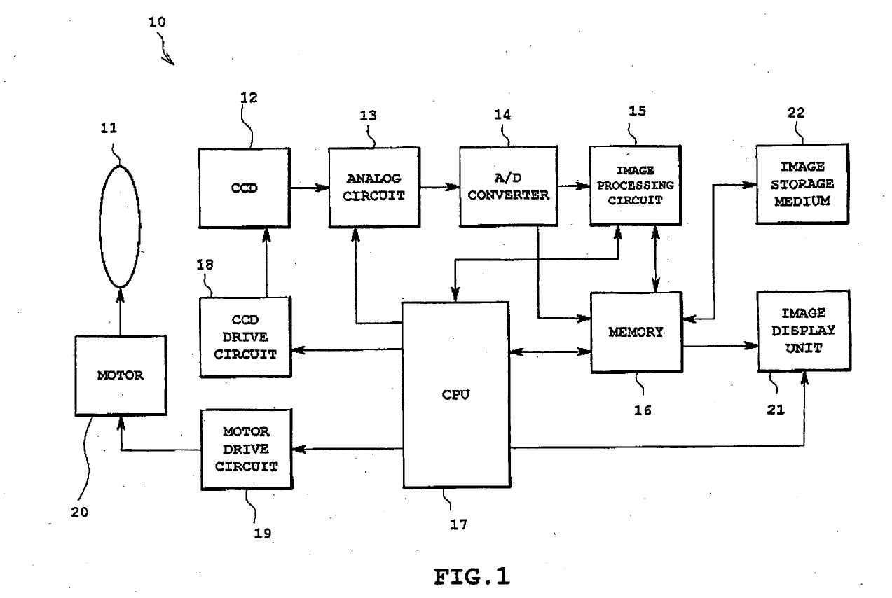

In FIG. 1, reference numeral 10 is an image capture device, and this image capture device 10 is a digital camera provided with a focusing device for taking still pictures or moving pictures, and comprises an optical system 11 provided with a lens and an aperture, a CCD 12 as an imaging element, an analog circuit 13 to which output of the CCD 12 is sequentially input, an A/D converter 14, an image processing circuit 15 constituting image processing means, memory 16 such as RAM etc. as storage means, a CPU 17 constituting control means constituting image processing means, a CCD drive circuit 18 controlled by the CPU 17 for driving the CCD 12, a motor drive circuit 19 controlled by the CPU 17 and constituting optical system drive means, a motor 20 driven by the motor drive circuit 19 and constituting optical system drive means for driving a focus lens of the optical system 11, backwards and forwards to vary focal length, an image display unit 21 such as a liquid crystal display etc., an image storage medium 22 such as a memory card, and also, although not shown in the drawing, a casing, operation means constituting image capture mode selection means such as an image capture button or a changeover switch, a power supply and input/output terminals etc.

The CCD 12 is a charge coupled device type solid-state imaging element, being an image sensor that uses a charge couple device, and is provided with a large number of pixels arranged at fixed intervals in a two-dimensional lattice shape on a light receiving surface. The CPU 17 is a so-called microprocessor, and performs system control. With this embodiment, the CPU 17 carries out aperture control of the optical system and focal length variable power control (focus control), and in particular drives the optical system using the motor 20 by the motor drive circuit 19, that is, varies the positions of a single or plurality of focus lenses backwards and forwards to carry out focus control. The CPU 17 also carries out drive control of the CCD 12 via control of the CCD drive circuit 18, control of the analog circuit 13, control of the image processing circuit 15, processing of data stored in the memory 16, control of the image display unit 21, and storage and reading out of data to and from the image storage medium 22. The memory 16 is made up of inexpensive DRAM etc., and is used as a program area of the CPU 17, work areas for the CPU 17 and the image processing circuit 15, an input buffer to the image storage medium 22, a video buffer for the image display unit 21, and temporary storage areas for other image data.

Subject light incident on the CCD 12 has light intensity regulated by controlling the aperture of the optical system 1 using the CPU 17. The CCD 12 is driven by the CCD drive circuit 18, and an analog video signal resulting from photoelectric conversion of the subject light is output to the analog circuit 13. The CPU 17 also carries control of an electronic shutter of the CCD 12 by means of the CCD drive circuit 18.

The analog circuit 13 is made up of a correlated double sample circuit and a gain control amplifier, and performs removal of noise in an analog video signal output from the CCD 12 and amplification of an image signal. Amplification level of the gain control amplifier of the analog circuit 13 is also controlled by the CPU 17.

Output of the analog circuit 13 is input to the A/D converter 14, and is converted to a digital video signal by the A/D converter 14. The converted video signal is either temporarily stored as is in the memory 16 to await subsequent processing, or is input to the image processing circuit 15 and subjected to image processing, followed by display using the image display unit 21 via the memory 16, or a moving image or still image is stored in the storage medium 22 depending on the user's intentions. Also, image data before processing that has been temporarily stored in the memory 16 is processed by either the CPU 17, the image processing circuit 15, or both.

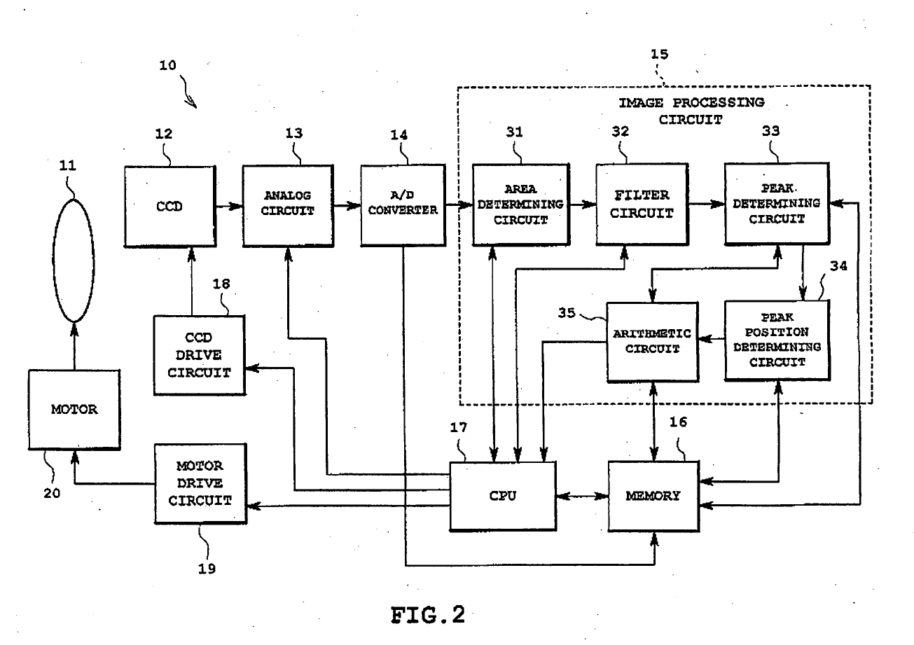

As shown in FIG. 2, the image processing circuit 15 of this embodiment is comprised of an area determining circuit 31, a filter circuit 32 as contrast detection means, a peak determining circuit 33, a peak position determining circuit 34, and an arithmetic circuit 35.

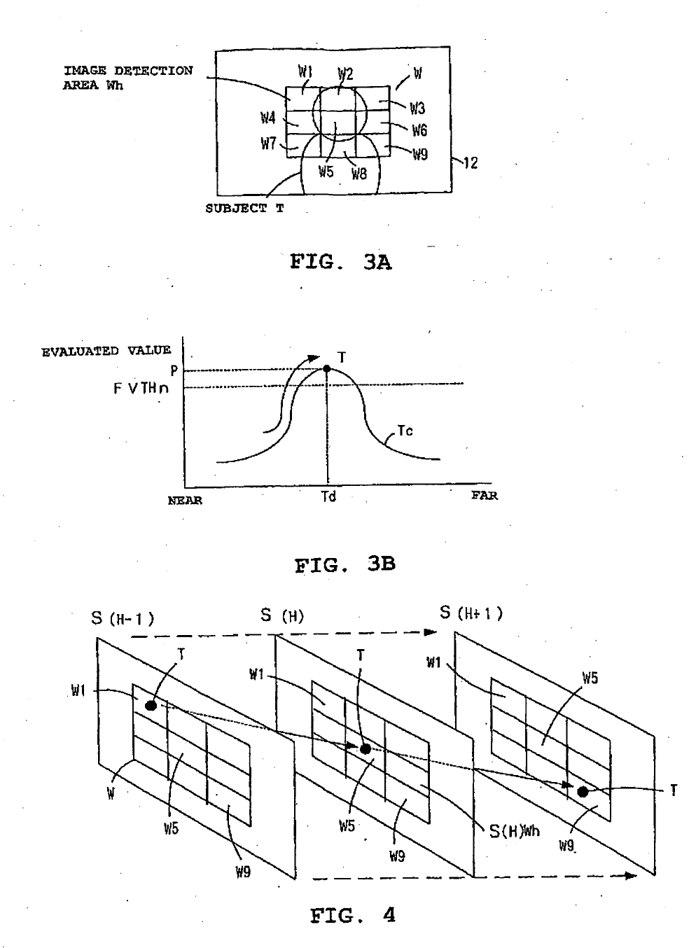

At a predetermined lens position, specifically, in a state where the optical system 11 has been set to an appropriate focal length, a subject image that is incident on the optical system 11 passes through the CCD 12 and made into an analog image signal, then converted to digital image data through the analog circuit 13 and the A/D converter 14. The digital image data output from the A/D converter 14 is stored in the memory 16, but in order to determine a focused image range W, being an image area for focusing as shown in FIG. 3 etc., area determining processing is carried out by the area determining circuit 31. This focused image range W has two or more image detection areas Wh, but here description will be given for the case where an image detecting area Wh is made up of windows W1 to W9, and there is means for calculating a focal length from an optical system 11 to a subject T (hereafter called subject focal length) in each of the windows W1 to W9, that is, in the range of a plurality of sections of a subject T. Specifically, in order to detect the magnitude of contrast of each of the windows W1-W9 of the focused image range W, high frequency components etc. are analyzed by the filter circuit 32, and contrast evaluated values are calculated for each of the windows W1-W9. This filter circuit 32 can accurately extract mage data contrast by using high pass filters (HPF) for extracting high frequency components of comparatively high frequency in order to detect contrast.

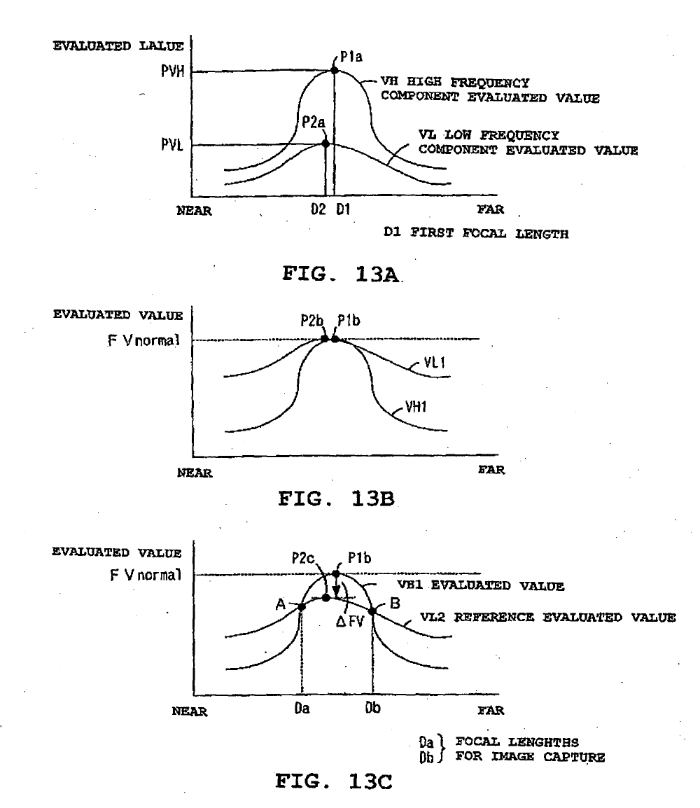

Also, with this embodiment, in order to detect moire, the filter circuit 32 is provided with a low pass filter (LPF) in addition to the high pass filter (HPF). As shown in FIG. 13A, for each window of each image data, high frequency components are extracted using the high pass filter, so that evaluated values for comparatively high contrast (high frequency component evaluated values VH shown in FIG. 3A) can be acquired, and at the same time, low frequency components are extracted using the low pass filter so that evaluated values constituting comparatively low contrast (low frequency component evaluated values VL shown in FIG. 3A) compared to the high frequency evaluated values can be acquired. With this structure, in a state where the lens is moved from the focused position, normally contrast of low frequencies varies only slightly compared to contrast of high frequencies, and occurrence of moire is detected utilizing the fact that contrast of low region frequencies occurring as moire varies similarly to contrast of high frequencies. In the following, description will be given of a structure for detecting contrast using high frequency components extracted by the high pass filter, and setting a first focal length.

With this embodiment, the highest evaluated value among the calculated evaluated values from each horizontal filter circuit 32 is output as an evaluated value for each of the windows W1-W9 by the peak determining circuit 33 for images of each window W1-W9. At the same time, a peak position determining circuit 34 is provided for calculating positions on the image data where the highest evaluated value is acquired by the peak determining circuit 33 (hereafter referred to as peak positions) from positions constituting start points of the windows W1-W9 being calculated. Output of these peak determining circuits 33 and the peak position determining circuits 34, namely the peak values of contrast evaluated values for each horizontal line of the windows W1-W9 and the peak positions where the peak position is stored, are temporarily held in the memory 16.

Peak values calculated for each horizontal line of the CCD 12 and peak positions are added inside each of the windows W1-W9 by the arithmetic circuit 35, as arithmetic means, a summed peak value for every window W1-W9 and a summed peak positions, being an average position of the peak position in the horizontal direction, are output, and the summed peak value and the summed peak position are passed to the CPU 17 as values for each of the windows W1-W9. The arithmetic circuit 35 for calculating summed peak values for each of the windows W1-W9 can be configured to calculate only peak values above a prescribed range.

Then the optical system 11 is driven, lens position is varied within a set range (drive range), and summed peak value and summed peak position for each lens position are calculated and stored in the memory 16. It is also possible to set this drive range, namely a number of exposures for focus processing, to an appropriate value according to lens magnification, distance information, and exposure conditions designated by the user. In this drive range, as shown below, it is also possible, in cases such as when the evaluated value is greater than a predetermined value FVTHn of FIG. 3B, to use evaluated value calculation results to reduce the number of exposures and shorten focusing time. In this drive range, peak values for each window W1-W9 are compared, and if there is a peak value for the drive direction of the lens it is set as a peak for each of the windows W1-W9.

Focusing on a subject T in the vicinity of this peak can then be estimated. Focal length estimated from this peak value is made a partial focal length of each window W1-W9. Here, in the focused image range W, because a plurality of windows W1-W9 are set, for example, there are windows where the subject T is moving close to the peak, and also windows where the subject T can be accurately captured without blurring close to the peak.

Specifically, among the partial focal lengths of each window W1-W9 there are some having high reliability (valid) and some having low reliability (invalid). The CPU 17 determines reliability for each of the windows W1-W9 using calculation results of the peak values and the peak positions, and weighting is carried out in focus position specifying means.

For example, if an average position of the peak position moves suddenly close to the partial focal length, or if an average position of the peak positions of the windows W1-W9 that are adjacent in the horizontal direction moves suddenly, it can be predicted that blurring will occur due to movement of the subject T, and therefore the weighting for those windows W1-W9 is made small. On the other hand, if the average position of the peak positions does not vary much it is determined that the subject T is not moving, and weighting is not made smaller.

Also, if the peak position of the subject T of a window moves into another window, the peak value and the peak position change significantly. As a result, for a window where the peak value and peak position have changed significantly, weighting is made small, that is, reliability is reduced, thus giving priority to partial focal lengths of windows where the subject T is captured. Since contrast peaks are evaluated in the horizontal direction within each of the windows W1-W9, if there are contrast peaks for the subject T within those windows W1-W9 there is no variation in the evaluated values even if the subject T moves.

In the event that the peak value and the peak position vary with movement of the lens position, there may be a lot of noise or no contrast within the windows, and as a result it is determined that there is no subject T, and weighting is made small.

As well as being set in advance, the extent of weighting can be calculated from image data evaluated values based on photographing conditions, such as brightness data, lens magnification etc.

The CPU 17 multiplies the evaluated value by the weighting for each of the windows W1-W9, to obtain weighted evaluated values.

If a weighted evaluated value is less than a predetermined value, the CPU 17, acting as determining means, invalidates that evaluated value and that value is no longer used.

The CPU 17 acting as determining means sums weighted evaluated values for each lens drive position and calculated a final focus position where contrast is at a maximum. Specifically, if evaluated value calculation results are passed to the CPU 17, evaluated values acquired in each of the windows W1-W9 (summed peak values and summed peak position) are added, and the subject position at the current lens position is calculated as one evaluated value. When performing this calculation, if a peak position is divided by a number of vertical lines within each of the windows W1-W9, a center of gravity of the peak position can be found. Summing is carried out by reducing weighting of a window evaluated value for large variation and movement of center of gravity in a window from a horizontal direction to a corner, to acquire a final evaluated value.

The smallest partial subject distance among the valid evaluated values is then selected, and this partial subject distance is selected as a focal length. Specifically, based on the magnitude of the final evaluated value, the CPU 17 instructs movement of the lens of the optical system 11 to a position where the final evaluated value is maximum, using the motor drive circuit 19 and the motor 20. If there is no variation in the final evaluated value, an instruction is issued to stop the motor 20 via the motor drive circuit 19.

Because of this weighting, erroneous selection of a peak value due to blurring of the subject T can be avoided, which means that it is possible to carry out selection without mistaking the subject T for blurring even with a plurality of focal length calculations having a plurality of areas. As a result, it is possible to correctly select focus position using means giving priority to focal length that is generally valid.

The focus position of the lens constituting the optical system 11, that is, the position where the lens is focused at a specified distance, is varied according to variation due to magnification factor and aperture position, and also varies depending on conditions such as temperature of the barrel holding the lens and positional error etc. In addition to the calculated drive range for focused position, considering amount of variation due to changes in these conditions the optical system 11 is provided with a variable drivable range at a short distance side and a long distance side, namely an overstroke region, and control means constituting the CPU 17 is set so as to be capable of driving the lens in this overstroke region.

For example, if total amount of variation in lens position is 10 mm when the designed photographing distance range is from 50 cm to infinity, and a maximum integrated value of this variation amount is 1 mm, overstroke regions are respectively provided of 1 mm at the sort distance side and the long distance side, and total variation in the lens focus position, namely drive range, is set to 12 mm (10+1+1). By providing overstroke regions in this way, since the lens position can be driven in this overstroke region it is possible to meet a designed photographing distance range.

Next, an automatic focusing operation of this embodiment will be described with reference to FIG. 3 to FIG. 10.

First of all, operation in the case of no subject blurring due to hand shake etc. will be described with reference to FIG. 3.

With this embodiment, as shown in FIG. 3A, the focused image range W is arranged at the center of the surface of the CCD 12, and this focused image range is also divided into three in the horizontal direction and three in the vertical direction giving 9 regions, namely the windows W1-W9.

It is possible to set the number of windows appropriately, as long as there are a plurality of adjacent areas. If the subject T is not blurred, it is arranged so that there is sufficient contrast in each of the windows W1-W9.

In the state shown in FIG. 3A, results of evaluating contrast are represented by the curved line Tc in FIG. 3A. This example shows maximum values resulting from summing of evaluated values in the case where a plurality of image data of a subject taken using the optical system 11 having focal point driven from near to far by the motor 12 are evaluated, and it will be understood that the subject distance Td is the peak P of the evaluated values. Next, operation in the case where there is subject blurring due to hand shake etc. will be described with reference to FIG. 4 to FIG. 6.

First of all, with reference to FIG. 4 description will be given of blurring due to movement of the subject of hand shake in a method having a plurality of regions.

FIG. 4 shows a case of relative movement of an image capture device 10 with respect to a subject T due to hand shake while photographing during a focus operation, and shows focused images for input image data while changing the lens position of the optical system 11 in time sequence from a scene S(H−1) through a scene S(H) to a scene S(H+1). Specifically, in this state if movement of the subject or hand shake occurs, with scene S(H−1), for example, a section where contrast of the subject is large in the window W1 moves relative to window W5 in the scene S(H) and moves relative to the window W9 in scene S(H+1). If contrast evaluated values are evaluated using only a specified window, such as window W1, in this state, correct evaluation is not performed.

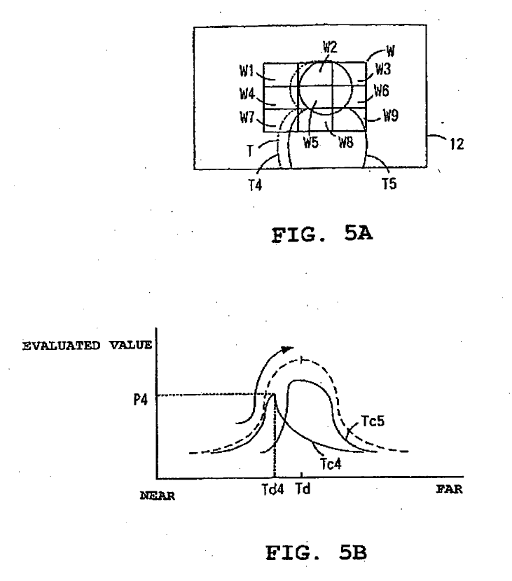

FIG. 5 also shows a case where hand shake occurs during a focus operation. FIG. 5A shows a case where a focusing image range W is set the same as with FIG. 3A, but there is subject blurring due to relative movement of the subject T from the position shown by the dotted line T4 to the position shown by the solid line T5, and a section where contrast of the subject T is large moves, for example, from window W4 to window W5. During movement of this subject T from T4 to T5, if a focusing operation to drive the lens of the optical system 11 is carried out, evaluated values resulting from evaluation of contrast of the window W4 are shown by the curved line Tc4, as shown in FIG. 5B, and results of evaluation of window W5 are shown by the curved line Tc5, and if the curved line Tc4 being the evaluation values for window W4 are taken as an example a position Td4, that is different from the subject distance Td, becomes an evaluation peak value P4, causing problems such as it not being possible to discriminate the existence of a plurality of subjects for each distance, etc.

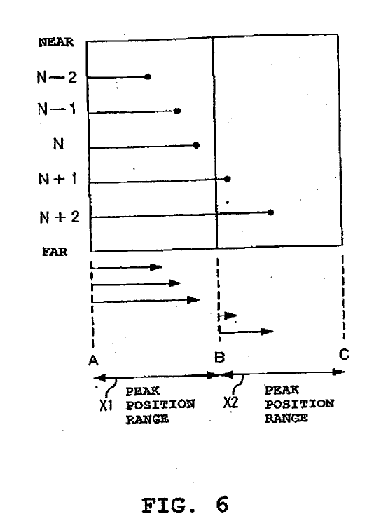

Also, FIG. 6 shows peak position moving relative to windows W1-W9. A range of peak positions when the subject T is moving in the horizontal direction is determined using the number of pixels in the horizontal direction of each of the windows W1-W9, with peak position X1 representing a situation where a reference point for peak position in the window W4 of FIG. 5A is made A and peak position X2 representing a situation where a reference point for peak position in window W5 of FIG. 5A is made B.

When the focal length of the optical system 11, that is the lens position, is made N, a direction closer to N is made N−1 while a far direction is made N+1. Here, at the point where the lens position of the optical system 11 moves from N−1 in a far direction to N+1 the peak position moves from window W4 to window W5. In this state, since the peak position varies clearly, it is easy to detect subject blurring even during a focusing operation.

However, even in cases where this type of image blurring arises, as long as a section where the contrast is large does not move across a plurality of windows, such as with window W9, there are windows having correct evaluation values. Accordingly, by using a weighting to reduce evaluation values for windows that have changed at the same time as detecting peak position varying section across a plurality of windows, it is possible to calculate correct evaluation value peak positions.

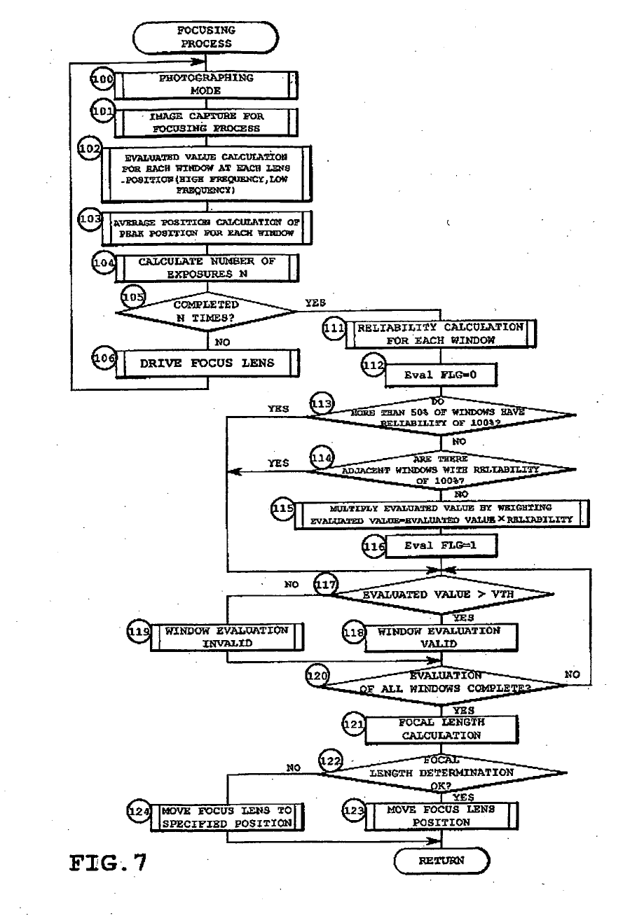

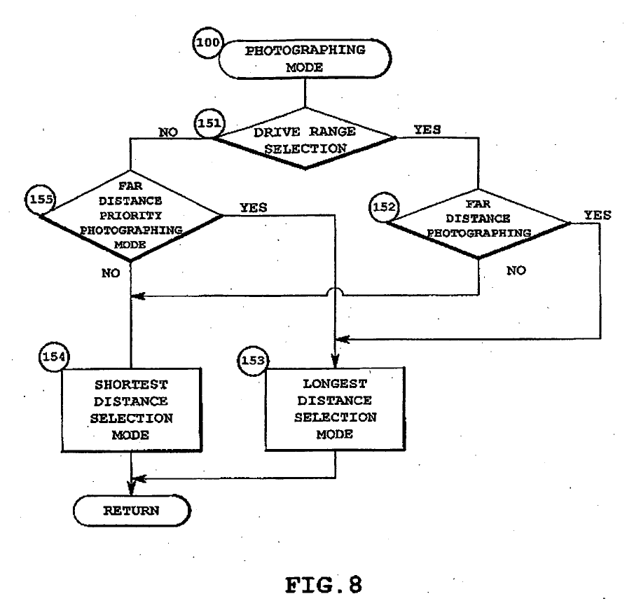

A focus control method for carrying out the above described weighting will now be described with reference to the flowcharts of FIG. 7 to FIG. 12. FIG. 7 shows the entire focusing process, while FIG. 8 to FIG. 12 show partial processes of the focusing process in detail.

With this embodiment, a photographer can select and set a long distance priority mode, in addition to a normal mode that is normal exposure mode, namely a short distance priority mode, and can designate a photographing distance range using a mode called distant view mode or infinity mode.

Specifically, with this structure operating means, being photographing mode selection means enabling a photographer to select long distance priority mode or short distance priority mode, is provided, and first of all as shown in FIG. 7 setting processing for photographing mode is carried out (step 100).

That is, when a photographing distance range is designated, first of all as focusing conditions photographing mode for the image capture device 10 is correlated, and it is necessary to ascertain a photographing distance range accompanying the lens movement range. If the photographing mode of the image capture device 10 is normal mode and the distance is from 50 cm to infinity, the lens drive range is set in response. Also, if the photographing mode of the image capture device 10 is capable of being set to other than normal mode, such as distant view mode (infinity mode) or macro mode, operation means to enable a photographer to designate the mode, that is, a photographing distance range, namely a lens drive range, is provided.

With this focusing processing, in a method of determining final focal length, the photographer operates the operation means provided in the image capture device 10 to select a photographing mode to either set short distance priority mode or long distance priority mode.

If the photographing mode of the image capture device 10 is long distance priority mode, furthest distance selection mode is set to drive the lens so that the furthest distance within the photographing image is made a focal length. Also, with short distance priority mode, shortest distance selection mode is set, to make the shortest distance from within the photographed image a focal length, and a generally used short distance priority photographing becomes possible.

Specifically, the photographing mode setting processing shown in FIG. 7 (Step 100) first of all determines whether a photographer has designated a photographing distance range (step 151), as shown in FIG. 8. Then, if mode selection is carried out to select a photographing distance range, it is also determined whether distant mode has been selected (step 152). If distant mode has been selected, shortest distance selection mode is set (step 153), while if distant mode has not been selected, that is, in the case of normal mode or macro mode, closest distant selection mode is selected (step 154). Specifically, whether photographing mode gives priority to long distance or to short distance is automatically determined according to the photographing distance range.

On the other hand, in step 151, if a mode for selecting a photographing distance range is not selected, it is also determined whether long distance priority mode has been selected (step 155).

If the photographer has selected long distance priority mode, longest distance selection mode is set (step 153), while if distant mode has not been selected, closest distant selection mode is selected (step 154). Specifically, photographing mode that can determine final focal length in a prioritized manner in line with the photographer's intentions is determined.

Returning to FIG. 7, with focus processing a plurality of image data is used, but at an initial lens position or a current lens position image capture for focus processing of one screen is carried out, and image data for a focused image range W is acquired (step 102).

Next, in captured image data, contrast evaluate values are calculated for each window W1-W9 of each focused image range (step 102). These evaluated values are high frequency component evaluated values, being contrast evaluated values for high frequency components, and low frequency component evaluated values, being contrast evaluated values for low frequency components, and in calculation of these evaluated values first of peak values for all lines in each of the windows W1-W9 are added using high frequency components. Next, relative positions from respective reference positions of peak values for all lines are obtained for each of the windows W1-W9, these relative positions are added up, and an average position of the subject T is calculated (step 103). Specifically, with this embodiment high frequency components are used for this calculation. A number of exposures N is then calculated (step 104), and until N exposures have been completed (step 105) photographing is carried out while moving the lens of the optical system 11 (step 106), that is, movement of the lens and image capture for focusing processing are repeated N time (steps 101-106) and evaluated values for consecutive image data are acquired.

In the event that the lens position driven in step 106 is comparatively close to the distance of the subject T, characteristics of contrast, the main feature of the subject T, are sufficiently reflected in the average position calculated in step 103 from the image data taken for focusing in step 101. As a result, particularly when the subject moves in windows having a lens position close to the distance of the subject T due to hand shake, the average position of the peak positions changes.

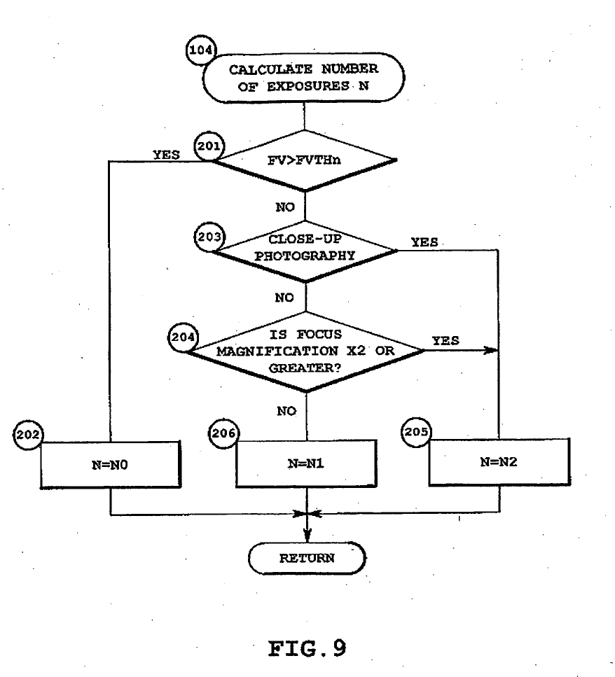

Description will now be given of a calculation section for the number of exposures N of image data at the time of a focusing operation (step 104), with reference to the flowchart of FIG. 9.

This setting of the number of exposures N is to acquire sufficient required image data by varying the number of exposures N according to magnification of the lens of the optical system 11 or distance information of the subject T to be photographed, or according to photographing conditions designated by the photographer.

First, an evaluated vale FV for high frequency components of each window W10 W9 calculated in step 103 of FIG. 7 (high frequency component evaluated value VH) is compared with a specified reference value FVTHn (step 201), and if the evaluated value Fv is larger than the reference value FVTHn N0 is input as N (step 202). It is also possible to do away with the processing of step 201, or to input N0 to N as a variable according to focus magnification. Also, in the event that the evaluated value FV is less than or equal to the reference value FVTHn (step 201), and near distance photographing mode is set as a result of the photographer's setting, being an operator of the image capture device 10, (step 203), or if focus magnification is comparatively large, for example 2× or more, N2 is input to N (step 205).

On the other hand, under conditions other than those described above, that is, in the event that the evaluated value FV is less than or equal to the reference value FVTHn (step 201), it is not near distance photographing (step 203), and focus magnification is comparatively small for example less than 2× (step 204), N1 is input to N (step 206). Here, the values N0, N1 and N2 have a relationship N0<N1<N2, and if it is near distance photographing and focus magnification is large the number of exposures N is made large a setting of lens drive of the optical system 11 is set finely to enable fine evaluation, but if the calculated evaluated value FV is greater than or equal to the specified reference value FVTHn, or if the subject T is close to the optical system 11, the number of exposures N is made small making it possible to shorten focusing time. Specifically, by providing means to carry out selective setting of lens drive range using evaluated values, it is possible to reduce focusing time without reducing accuracy of focus.

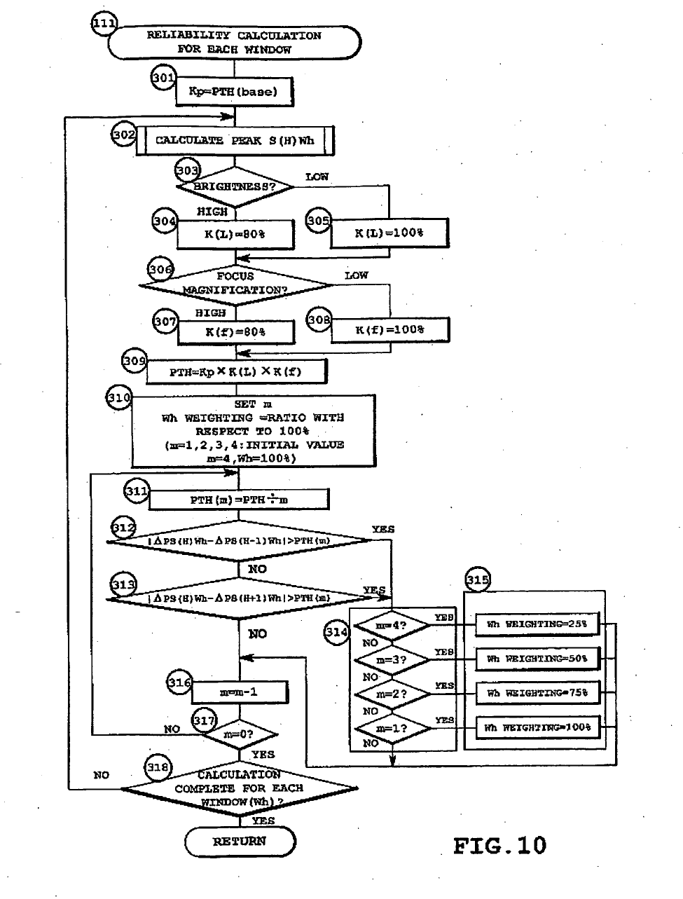

As shown in FIG. 7, hand shake or the like is judged for average position of peak positions acquired through the N exposures, and a weighting, being reliability for each of the windows Wh (W1-W9), is calculated (step S111). Calculation of weights using this judgment means will now be described with reference to the flowchart of FIG. 10.

With this processing, first of all Kp=PTH(base) is set in advance (step 301), and is an initial value of peak value average position movement amount PTH, and for each window Wh in the focused image range W capturing each scene, a single or numerous scenes S(h)Wh representing the highest evaluated value from evaluated values calculated in step 102 is acquired (step 302).

Also, this peak value average position movement amount PTH is used as a final judgment value for selecting weight of each window Wh, and is a variable that changes according to photographing conditions, such as brightness, focal length, etc.

Specifically, in cases where brightness of a photographed scene is comparatively high (step 303), as shutter speed is comparatively high amount of movement inside a window Wh tends to be smaller.

A percentage of the peak value average position movement amount PTH is set smaller than the initial value kP=PTH(base) that is set in advance, that is, a percentage K(L) for multiplying the peak value average position movement amount PTH by is set, for example, to 80% (step 304).

On the other hand, if the brightness of a photographed scene is comparatively low (step 303), the percentage K(L) is set at 100% (step 305). Continuing on, when focus magnification is comparatively high (step 306), compared to when focus magnification is low there is a higher possibility of hand shake, so the percentage of the value of peak value average position movement amount PTH is made smaller than the initial value PTH(base) set in advance, that is, a percentage K(f) for multiplying the peak value average position movement amount PTH by is made 80%, for example (step 307). On the other hand, if the focus magnification is comparatively low (step 306), the percentage K(f) is set at 100% (step 308).

The initial value PTH(base) set in advance is multiplied by percentages K(L) and K(f) acquired for brightness and focus magnification, to calculate a peak value average position movement amount PTH as an optimum judgment value in a photographed scene (step 309). Specifically, calculation of PTH=Kp×K(L)×K(f) is carried out. The peak value average position movement amount PTH has been calculated here according to brightness and focus magnification, but if it is possible to obtain an optimum judgment value in advance it is possible to use the initial value PTH(base) of the peak value average position movement amount as is as the peak value average position movement amount PTH.

Next, reliability of each window Wh is calculated, and first of all a weighting factor, being an amount of weight, is initialized (step 310). This weighting factor is represented as a proportion of 100%, and is initialized to 100%, for example. At the same time, a variable m is set so that the weighting factor can be set as a variable according to obtained peak value average position movement amount PTH. For example, if weighting factor is set at four levels, m can be 4, 3, 2 or 1, and the initial value is 4.

When determining a weight, a percentage with respect to the obtained peak value average position movement amount is set in a variable manner to peak value average position movement amount PTH(m) using the variable m (step 311). Specifically, peak value average position movement amount PTH(m) is obtained by dividing obtained peak value average position movement amount PTH by the variable m.

When an absolute value of a difference between a peak value average position ΔPS(H)Wh shown in the scene S(H)Wh and a peak value average position ΔPS(H−1)Wh shown in the previous scene S(H−1)Wh is larger than a peak value average position movement amount PTH(m), the CPU 17, acting as determining means, determines that the subject T has moved across the windows W1-W9, or that evaluated value calculation has been influenced, because of hand shake (step 312). When an absolute value of a difference between a peak value average position ΔPS(H)Wh shown in the scene S(H)Wh and a peak value average position ΔPS(H+1)Wh shown in the next scene S(H+1)Wh is larger than a peak value average position movement amount PTH(m), the determining means, determines that the subject T has moved across the windows W1-W9, or that evaluated value calculation has been influenced, because of hand shake (step 313).

On the other hand, if both absolute values of these differences are less than or equal to the peak value average position movement amount PTH(m), it is determined that there is no handshake or evaluated value calculation has not been influenced, and the weighting factor for that window Wh is not lowered. As the variable m increases, the peak value average position movement amount PTH(m) that is compared decreases judgment of the peak value average position movement amount becomes difficult a weighting factor is determined according to that peak value average position movement amount PTH(m) (step 315). Then, in step 312 or step 313, if either of the absolute values of the difference are larger that the set peak value average position movement amount PTH(m), it is determined that there is handshake, weighting for that window Wh is lowered, and the weighting factor is lowered to 25% of the maximum, for example (step 315). This comparison operation is then is repeated (step 311-317) until the variable m becomes 0 by subtracting 1 from the initial value of 4 each time (step 316), and a weighting is determined for each variable (step 314, 315). The minimum weighting factor is set to 25%, for example, but this is not limiting, and it can also be set to the minimum of 0%, for example. Also, the peak value average position movement amount PTH(m) is set as a percentage of the peak value average value movement amount PTH obtained in the previous step, but if possible, a plurality of predetermined optimum determined values can also be used.

In this way, by determining whether or not there is handshake by providing a plurality of determination references, it is possible to set reliability level to a plurality of more finely divided levels.

This operation is repeated (step 301-318) until calculation has been completed for all windows W1-W9. Using this weighting it is possible to quantify reliability of each of the windows W1-W9 as a weighting factor.

By carrying out the above described processing for windows adjacent to the window S(H)Wh, it is possible to ascertain whether or not there has been any influence of movement of the subject constituting a peak, such as hand shake. Specifically, as shown in FIG. 7, after calculating weighting factor (reliability) of each window Wh, first of all EvalFLG is set to 0 (step 112). After that, in the event that the number of windows Wh having weighting factor, namely reliability, of 100% is greater than or equal to a predetermined value, for example 50% (step 113), or in the event that reliability of adjacent windows Wh is greater than or equal to a predetermined value, for instance there are adjacent windows both having reliability of 100% (step 114), it is determined that there is no movement of the subject T in the scene, and whether or not the evaluated value is larger than a predetermined determination value is compared (step 117) to determine if they are valid or invalid, without carrying out evaluation weighting described in the following.

On the other hand, if neither of the conditions of step 113 or step 114 are satisfied, calculation processing that adds weighting factor is carried out, as described below. Specifically, after calculating weighting factor for each of the windows W1-W9, the obtained weighting factor is multiplied by all evaluated values for each of the windows W1-W9, and evaluated value weighting is reflected in each evaluated value itself (step 115). At this time, in order to show that calculation processing adding weights has been carried out, EvalFLG is set to 1 (step 116).

Comparison is then carried out to see if each weighted evaluation value is larger than a predetermined determination value VTH (step 117), and an operation to determine whether it is valid (step 118) or invalid (step 119) as an evaluation subject is carried out for all windows W1-W9 (step 117-120).

Then, if a plurality of windows are valid, the CPU 17 carries out focal length calculation from among focus positions, namely partial focus position, for windows that have been made valid (step 121) to obtain focal length.

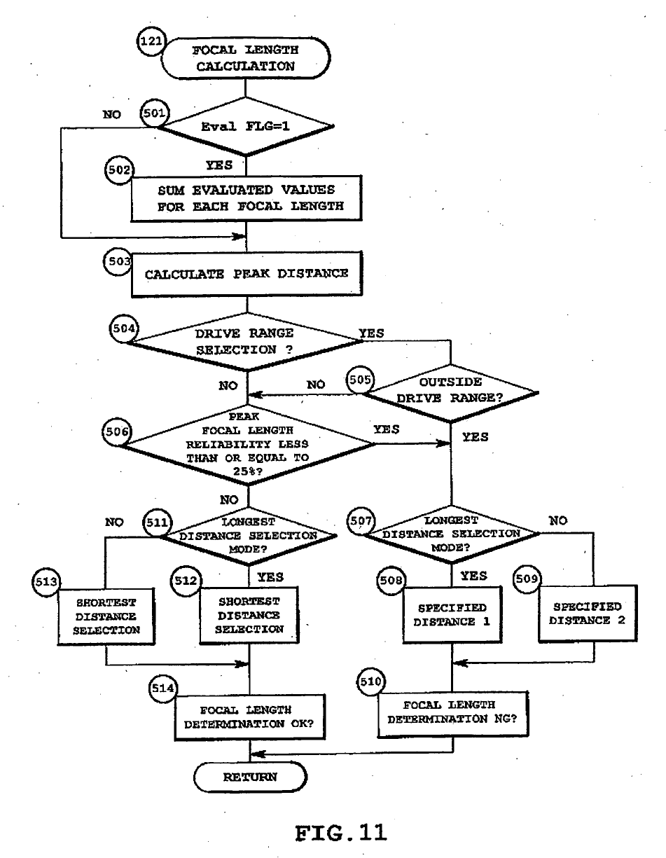

Focal length calculation of step 121 is shown in detail in FIG. 11. Here, first of all whether or not weight has been added in calculation of the evaluated value is determined from the state of EvalFLG (step 501), and if there is weighting those evaluated values are added for each distance (step 502) while if there is no weighting they are not added. From these evaluated values, a peak focus position (peak position) is obtained (step 503), as will be described later. Based on the photographing mode determined in step 100 of FIG. 7, if drive range selection is set (step 504), in the event that all of these peak focus positions are outside of a set photographing distance range (step 505), or the reliability of all peak focus positions is less than or equal to a specified value, for example, 25% or less (step 506), it is determined that calculation of subject distance is not possible (step 507). In this case, a specified distance is forcibly set as the focus position (position of the focal point) according to the photographing mode set in advance in step 100. Here, since the photographing mode is shortest distance selection mode or longest distance selection mode, in the event that calculation of subject distance has been determined to be impossible, it is determined whether or not it is longest distance selection mode (step 507), and in the event of longest distance selection mode a specified distance 1 is set (step 508), while if it is not longest distance selection mode a specified distance 2 is set (step 509). Here, the specified distance 1 is set to a longer distance than specified distance 2 (specified distance 1>specified distance 2). It is then determined that focal length determination is NG (step 510).

Also, based on photographing mode set in step 100 of FIG. 7, even if drive range selection has not been set (step 504), in the event that reliability of all peak focus positions are less than or equal to a specified value, for example 25% or less (step 506), it is determined that subject distance calculation is not possible (step 507) and the same processing is performed (step 508-510).

On the other hand, in step 504-505, in cases other than those described above, namely when drive range selection has been set (step 504), there is at least one peak focus position in a photographing distance range corresponding to the set photographing mode, and peak focus position within the set photographing distance range have a reliability greater than a specified value, for example larger than 25% (step 506), it is determined that calculation of subject distance is possible. Then, in determining peak position, within selection mode determined by photographing mode of step 100, if it is longest distance selection mode (step 511) a partial focus position having the furthest peak position is selected from among valid windows W1-W9 and this position is made a focus position (step 512), while if it is not longest distance selection mode (step 511), that is, it is shortest distance selection mode, a partial focus position having the closest peak position is selected from among valid windows W1-W9 and this position is made a focus position (step 513). It is then determined that focal length determination is OK (step 514).

Also, based on photographing mode determined in step 100 of FIG. 7, even if drive range selection has not been set (step 504), if there is at least one peak focus position having a reliability larger than a specified value (step 506), for example a peak focus position having a reliability of larger than 25% (step 506), it is determined that subject distance calculation is possible and the same processing is performed (Step 511-514).

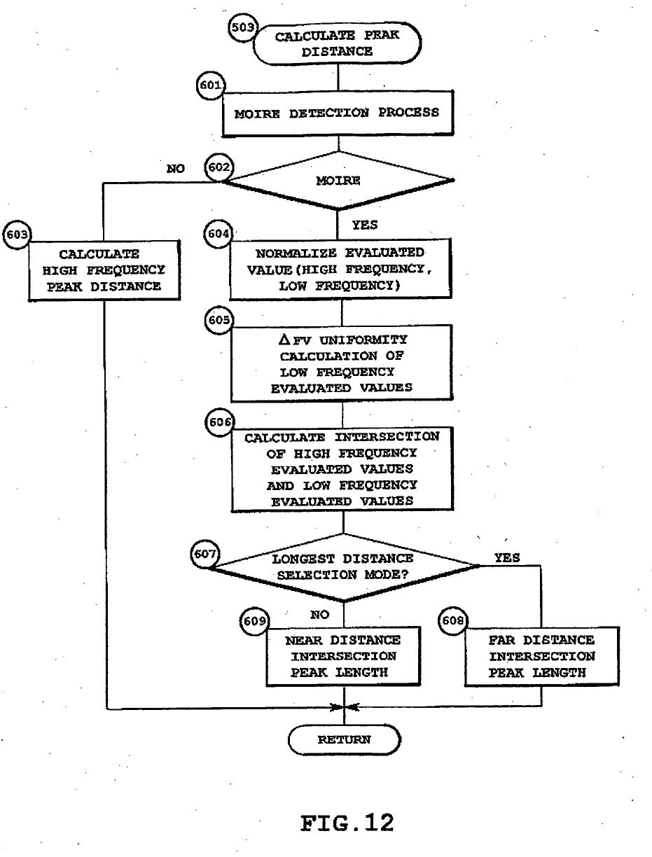

Next, processing for peak distance calculation to obtain a peak focus position (peak position) in step 503 of FIG. 11 will be described with reference to explanatory drawings for describing the theory of FIG. 13, and the flowchart of FIG. 12.

First of all, using high frequency component evaluated values that are evaluated values for contrast of high frequency components acquired in step 102 of FIG. 7, and low frequency component evaluated values that are evaluated values for contrast of low frequency components, it is detected whether moire occurs in each image area, namely in each of the windows W1-W9 (step 601). With this moire detection method, in a state where the lens is moved from the focused position, normally contrast of low frequencies varies only slightly compared to contrast of high frequencies, and occurrence of moire is detected utilizing the fact that contrast of low region frequencies occurring as moire varies similarly to contrast of high frequencies. Specifically, when an amount of variation in low frequency component evaluated values exceeds a fixed percentage with respect to amount of variation in high frequency component evaluated values, it is determined that moire has occurred.

In this moire detection process (step 601), if there is no moire in each of the windows W1-W9 (step 602), a high frequency peak distance D1 as a first focal length obtained using high frequency component evaluated values is made a peak distance as the focal length for image capture (step 603), and processing reverts to the flowchart of FIG. 11.

On the other hand, if there is moire in each window W1-W9 (step 602), then first of all the normalization described in the following is carried out for high frequency component evaluated values and low frequency component evaluated values obtained in each of the windows W1-W9 (step 604). As this normalization, as shown in the graph of FIG. 13A, for the obtained high frequency component evaluated values VH and the low frequency component evaluated values VL, a peak value PVH (peak position P1a, distance D1) of the high frequency component evaluated values VH and a peak value PV1 (peak position P2a, distance D2) of the low frequency component evaluated values VL are respectively obtained, and calculation is performed so that these peak values PVH and PVL become the same (FVnomal) to obtain percentages for evaluated values VH, VL for each photographing distance, for example, as shown in the graph of FIG. 13B, a value is uniformly multiplied by or added to the low frequency component evaluated values VL for each photographing distance, to obtain high frequency component evaluated values VH1 (peak position P1b) and low frequency component evaluated values VL1 (peak position P2b) constituting evaluated values. Then, because of this normalization, a relationship between relative focus positions and evaluated values due to frequency regions of the subject becomes comparable.

Next, a value ΔFV for uniform subtraction is obtained in all of the low frequency component evaluation values VL1, and as shown in FIG. 13C, subtraction is carried out from the low frequency component evaluated values VL1 using this value ΔFV, and low frequency component evaluated values VL2 (peak position P2c) are obtained as reference evaluated values (step 605). This value ΔFV is either calculated using characteristics of focus magnification and aperture amount, MTF (modulation transfer function) inherent to the lens, or CCD resolution, photographing conditions, photographing mode and variation in camera characteristics, or set using a previously supplied data table. For example, in cases such as high focus magnification or aperture value at an opening side being small, since depth of field is small, because moire is reduced even if there is slight movement of focus position from a peak position it is possible to set a comparatively small value as the value ΔFV. Conversely, in cases such as low focus magnification or aperture value at an opening side being large, since depth of field is large, because moire is not sufficiently reduced if there is not significant movement of focus position from a peak position, it is necessary to set a comparatively large value as the value ΔFV.

In a calculation method for reference evaluated values based on low frequency component evaluated values and evaluated values based on high frequency component evaluated values, that is, a method for calculating offset component for evaluated values, as well as subtraction of low frequency component evaluated values it is also possible to carry out division of the low frequency component evaluated values or relatively subtract values from the high frequency component evaluated values.

It is also possible, together with calculation of low frequency component evaluated values, or instead of calculation of low frequency component evaluated values, to add or multiply high frequency component evaluated values to carry out calculation to cause relative increase.

Two points where a graph of low frequency component evaluated values VL2 calculated using the value ΔFV set in step 605 and a graph of high frequency component evaluated values VH1 cross, that is, a near distance cross point A (peak distance Da) and a far distance side cross point B (peak distance Db) for a peak position P1b of the high frequency component evaluated values are then obtained. Specifically, a range between the distance Da and the distance Db is a range where moire occurs and is not suitable for photographing.

Depending on the photographing mode set in step 100 of FIG. 7 and in FIG. 8, if longest distance selection mode is being selected (step 607), the peak distance Db for the far distance side cross point B of the two cross point is selected to set a peak distance for setting image capture focal length (step 608), while if longest distance selection mode is not being selected (step 607) the peak distance Da for the near distance side cross point A of the two cross point is selected to set a peak distance for setting image capture focal length (step 608).

In this focal length calculation, when there is weighting, in step 502 respective evaluated values are summed, resulting in a single evaluation value and a peak position constitutes a center of gravity where a plurality of evaluated values are included, but this is not limiting and it is also possible for the peak position to select only a near distance window, and in adding for each window a partial focal length is calculated and this position is made a focus position. Also, when there is no weighting, it is possible to select the closest partial focus position from windows having valid evaluated value to give a focus position.

Then, depending on the results of focal length determination obtained from this type of focal length calculation (step 121), as shown in FIG. 7 determination of whether focal length determination is OK or NG is carried out (step 122), and if it is OK a peak distance as a calculated image capture focal length is made a focus position and the lens of the optical system 11 is moved (step 123) while if it is NG the lens of the optical system 11 is moved to a specified distance 1 or specified distance 2 that are specified focus positions that have been set in advance (step 124), and in this way it is possible to arrange the lens at the final focus position.

In this way, according to this embodiment, when moire is detected the image capture device 10 makes it possible to reduce moire by moving focal length, and because a focus position having positions that would cause a moire image to be removed is selected when focus position is calculated, movement amount of the focal length is automatically set to a sufficiently required amount to appropriately suppress moire, making it possible to capture a high quality image with no moire.

Specifically, this embodiment comprises detection means for detecting evaluated values for high frequency components and low frequency components from within partial focal lengths of an image detection region (refer to step 102 of FIG. 7) and detection means for detecting moire from these evaluated values (refer to step 601 in FIG. 12), and in the event that moire is detected two different evaluated values for each frequency component (low frequency component evaluated value and high frequency component evaluated value) are respectively normalized to peak values (refer to step 604 in FIG. 12). There is also means for calculating offset amount of evaluated values according to photographing conditions, which is photographing distance calculating means for calculating a cross point of the low frequency component evaluated values and the high frequency component evaluated values as a photographing distance, or focal length for image capture, by either subtracting the offset amount from the low frequency component evaluated value (refer to step 605 in FIG. 12) or adding the offset amount to the high frequency component evaluated value for the normalized evaluated values (refer to step 606 in FIG. 12).

Specifically, moire detection means for detecting moire for every partial focal length obtained for every image signal using evaluated values for detecting contrast of high frequency components and low frequency components from a plurality of captured mage signals is provided (refer to FIG. 12 and step 601), and if moire is detected the high frequency component evaluated values and the low frequency component evaluated values are normalized to respective peak values (refer to FIG. 12, step 604), and for relative comparison of each evaluated value in this binarization moire section within high frequency component evaluated values are identified, and as a result offset for low frequency component evaluated values is calculated according to photographing conditions, and a cross point of the high frequency component evaluated values and the low frequency component evaluated values is obtained by subtracting this evaluated value offset from low frequency component evaluated values (refer to FIG. 12, step 606).

Evaluated values of sections where this cross point is exceeded are then determined to contain a lot of moire patterns, and it becomes possible to reduce the moire by driving the lens so that a partial focus is aligned with an evaluated value section below this cross point.

With an image capture device provided with moire occurrence detection means, it is possible to reduce moire by offsetting a photographing distance from a focus position, being a peak position of subject evaluated values, when moire is detected, but conventionally there has been no clear structure for specifically calculating this offset amount, it was not possible to sufficiently suppress moire if offset amount was too small, and if offset amount was too large image data having focus offset from the subject was obtained.

For example, with a structure for taking pictures having a permissible circle of confusion for the subject from a focus position, there is still a moire effect. Also, with a predetermined offset amount, it may not be the optimum offset for a subject to be photographed.

In this respect, with this embodiment photographing distance offset amount is calculated according to actual evaluated values using photographing conditions such as focus magnification and aperture amount, MTF characteristics inherent to the lens, and CCD resolution and information required at the time of photographing, such as characteristics of the image capture device 10, and relative offset amount of evaluated values obtained from calculation processing according to these conditions, and as a result it is possible to set a sufficient photographing distance offset taking into consideration both the photographing setting conditions and the subject conditions.

Then, if a focal length is to be selected from a plurality of image regions, selection is made from within a mix of image regions where moire is detected and image regions where moire is not detected, but in the case where the photographing mode is near distance priority mode, for example, in image regions where moire has been detected focal length for a near distance side is selected while in image regions where noire is not detected an evaluated value peak position is selected, and by making a focus position of an image region constituting the closest distance side (refer to FIG. 11, step 513) from these selected partial focal lengths the final focus position, the final focal length can be set taking into consideration reduction of moire.

Also; offset amount calculated with this embodiment is obtained from a cross point of two graphs of high frequency component evaluated values and low frequency component evaluated values, which means that normally two cross points, namely a far distance side and a near distance side, for peak distance using high frequency evaluated values are calculated as candidates for image capture focal length, and it is possible to take a photograph reflecting the photographer's intentions by selecting image capture focal length from these two points according to photographing mode set by the photographer etc.

Also, focal length is selected according to photographing mode from a plurality of image regions, and within a focal length range it is possible to make a near distance side or far distance side capable of the highest reliability within the subject the focal length.

Accordingly, even when moire occurs at the final focal length, with this embodiment it is possible to set the focal length towards a closer distance side or a further distance side, and it is possible to further suppress the occurrence of moire in the subject.

Since it is possible to take measure against moire as described above, and to remove moire taking the subject into consideration, it is not necessary to use an optical filter to suppress moire, it is possible to improve image quality in a state where moire does not occur, and it is possible to provide a cost effective image capture device with a simple structure.

Also, since, using high frequency component evaluated values and low frequency component evaluated values, and it is possible to specify a moire range, that is a lens offset amount, the load on the CPU 17 etc. is reduced and it is high speed processing is made possible.

This embodiment has means for detecting contrast evaluated values of respective mage signals (A/D converter 14) from within a plurality of photographed image detection regions, means (A/D converter 14 and image processing circuit 15) for carrying out calculation processing for focus processing for each of the plurality of image detection regions and performing calculation processing on contrast evaluated values acquired from the plurality of image detection regions, and means for moving a lens position focusing on the subject by carrying out weighting processing on the evaluated values for each image signal acquired by the above described selection and means.

In an automatic focusing device, namely focal length detection method, utilizing image data used in an image capture device such as a digital camera or a video camera, a screen is divided into a plurality of regions, and in an automatic focusing operation of a method for determining respective focus position in each region reliability is calculated according to movement of a peak value of contrast evaluated values across image data of stored positions. As a result, partial focal lengths for image detection regions having low reliability where there is relative movement of a subject are removed from selection subjects, and even in scenes that are impaired at a distance, due to movement of the subject or hand shake, blurring is detected, and appropriate distance is measured using only optimal data, that is, focal length is accurately detected and it is possible to focus the optical system 11.

Specifically, in the event that respective evaluated value peaks are calculated in a plurality of regions, compared to a structure where a partial focus position, being a focus position representing the highest evaluated value, is simply set as a focus position, using evaluated value weighting means for adding reliability partial focal lengths acquired from windows having low reliability due to hand shake etc. are removed, determination is carried out using only evaluated values enabling reliability, and by using closest partial focal length among valid evaluated values the probability of accurate focusing is improved, and it is possible to take focused photographs by determining the focus position accurately.

This functions particularly effectively with high magnification models where the zoom magnification of the optical system 11 is high.

Also, in the case of evaluated values when there are no evaluated values or valid subject inside a particular window due to the effects of noise etc, or when the evaluated value itself is low before weighting, by making that window invalid it is possible to accurately detect focal length.

Specifically, in a plurality of focal length calculations having a plurality of regions, in a case where near distance that is made valid takes priority, with a conventional method, if an erroneous peak is at a closer distance than a subject due to movement of the subject or handshake, it is not possible to determine the subject as a focus position, the erroneous peak is determined as a focus position, and there may be cases where the focus position can not be set correctly, but with this embodiment, even if an erroneous peak is at a near distance due to movement of the subject or hand shake, movement of the subject and hand shale are detected, and it is possible to correctly and appropriately set a focus position that gives priority to near distance using only optimal data.

Also, with a conventional method that caries out compensation for image blur of a subject and handshake by changing image detection regions and carries out evaluation of a focal point again after changing the image detection regions, it takes time to calculate the focus position, and photo opportunities may be missed, but with this embodiment, since focus position is calculated from only information supplied from predetermined image detection regions rapid processing becomes possible, and it is possible to make the most of photo opportunities.

Also, it is not necessary to provide a special unit such as an acceleration sensor for detecting image blurring of a subject or handshake, which simplifies the structure and makes it possible to reduce manufacturing cost.

Since reliability of a plurality of calculated subject distances is high, it becomes possible to incorporate other algorithms.

Further, since evaluated values are acquired inside predetermined image detection regions to calculate focus position, it is possible to prevent a photographer's discomfort due to focusing on a subject in a way they did not intend.

Because there is no effect on brightness variation of an image having flicker due to fluorescent lights etc. and the peak position of image evaluated values does not change, it is possible to evaluate reliability for each of a plurality of regions regardless of the magnitude of the evaluated values.

According to this embodiment, focusing is also made possible at a far distance side in response to a photographer's intentions, which means that it is possible to easily take photographs that are focused at a far distance in line with the intentions of the photographer.

Specifically, according to a photographing distance range, it is possible to select a mode for taking photographs with near distance priority of far distance priority while making a photographing distance range constituting a normal mode and a mode or photographing distance range that is an object of photographing a long distance, being a distant view mode of infinite mode an overall photographing distance range of a lens, which means that it is possible to easily and accurately take photographs in line with the photographer's intentions by selection. Determination of these focus positions uses data that has focus determined as valid capable of evaluation if there is no influence due to rapid movement of the subject from the plurality of image regions, which means that it becomes possible to take photographs that reflect the photographer's intentions. Specifically, a screen is divided into a plurality of regions, and in an automatic focusing operation of a method for determining respective focus positions in each region, for scenes that are impaired at a distance due to movement of the subject or hand shake, blurring is detected, distance is appropriately measured using only optimum data and it is possible to focus the optical system, which means that focus accuracy in a long distance mode is improved.

Specifically, in calculation of a plurality of focal lengths having a plurality of regions, and final focal length determination, in the case where generally valid focal lengths are given priority, with a conventional method if an erroneous peak is at a closer distance than the subject due to movement of the subject or hand shake, the subject can not be determined as a focus position, the erroneous peak is determined as a focus position and there may be cases where it is not possible to correctly set focus position. Also, in the case where the intention is not to photograph a subject at a close distance but to photograph the subject at a far distance, conversely a close distance peak is erroneously determined as a focus position due to subject movement or hand shake, or a peak further to a far distant side (for example, a further distance that a subject at a maximum distance if a photographed image) than a far distance intended by the photographer is erroneously determined as a focus position, and there may be cases where the photographer's intentions are not reflected. In this respect, according to this embodiment even if there is an erroneous peak at either a near distance or a far distance due to subject movement or hand shake, movement of the subject and hand shake are detected, determination is appropriately carried out using only correct evaluated values, and it is possible to set a correct focus position with near distance priority or far distance priority according to the photographing mode.

Also, in the photographing distance range, if normal mode is set closest distance selection mode is automatically set, and if the photographing distance range is set to long distance furthest distance selection mode is automatically set, which means that the closest in the photographing distance range selecting in long distance, mode is mot made a final focus position, it is possible to set a subject at the furthest distance among a plurality of image regions as a final focus position, and photographing in line with the photographer's intentions is made possible.

Also, with a structure for making it possible to select far distance priority mode and near distance priority mode in the entire photographing range, it is possible to have a photographer select only far distance priority mode, it is not necessary for a user to perform a complicated operation to determine in advance photographing distance range by visual estimation, namely whether a macro region or a normal region, and after evaluation of reliability correlation with an accurate focus operation to determine final focus distance is carried out to enable accurate photographing at a focus that matches the intentions of the photographer.

It is also possible to cause accurate focus even at long distance other than infinity by using long distance priority mode.

Further, since there is a structure for calculating and evaluating respective subject distances in a plurality of regions, even in the event that the subject moves or the background is blurred it is possible to reduce the fear of erroneous operation, and even in the event of severe conditions where accurate evaluation of focus position is not possible, namely when evaluated values using contrast are low in all image regions it is not possible to acquire valid focus position and ranging is impossible, photographing that reflects the photographer's intention becomes possible as a result of making a specified distance a focal length depending on the photographing mode.

Also, with this embodiment, since the intentions of a photographer clearly represented by near distance priority or long distance priority are complied with, compared to a structure for automatically recognizing a camera to determine focal length using an empirical rule from an image in addition to near distance priority or far distance priority, confirmation of focal length is intuitively possible before photographing, it is not necessary to use a complicated algorithm, and also it is not necessary to provide devices such as a single lens reflex optical viewfinder or an enlargement display with a liquid crystal panel using computer components, the structure is simplified and it is possible to reduce manufacturing costs.

A drive range of the lens is varied in the designed photographing distance range due to variation with focus magnification or variation caused by aperture position, and due to conditions such as temperature of a barrel supporting the lens and attitude difference etc. In addition to the designed drive range for focused position, considering amount of variation due to changes in these conditions the optical system 11 is provided with a variable drivable range at a short distance side and a long distance side, namely an overstroke region, and control means constituting the CPU 17 is set so as to be capable of driving the lens of a focusing lens section in this overstroke region.

In the case of longest distance selection mode, the focused position approaches a far distance end of the lens drive range, and even if there is an attitude difference at the far distance side, by moving a lens drive position of a focusing lens section to an overstroke region at the far distance side it is possible to satisfy the photographing distance range, and regardless of offset in focus of the optical system sue to temperature or attitude it is possible to achieve accurate focus at a near distance or a far distance.

Also, in the case of shortest distance selection mode, the focused position approaches a shortest distance end of the lens drive range, and even if there is an attitude difference at the near distance side, by moving a lens drive position of a focusing lens section to an overstroke region at the near distance side it is possible to satisfy the photographing distance range.

In this way, for a near distance side and a far distance side, it is possible to take pictures taking into consideration offset amount of focus, and since it is possible to easily satisfy designed photographing distance range there is no need for a high precision distance compensation operation carried out in a mechanical or control (software) manner, and it is possible to reduce manufacturing cost. Also, with the above described embodiment, evaluated values for a plurality of positions are acquired while tracking operation of the optical system, and a so-called hill-climbing measurement method for determining peaks at time points where evaluated valued turn downwards after an increase is adopted, but in the case of subject blur the peak positions move inside each window, and moves into an adjacent window W1-W9.

When a peak section of contrast of the subject T moves from one window to another window, a peak value of the evaluated value also decreases sharply. By reducing weighting in windows having an evaluated value that varies sharply for previously and subsequently captured scenes, data of hand shake is eliminated and only optimum data is used making it possible to correctly measure distance and perform focusing.

Also, with the above-described embodiment peak positions of evaluated values are summed and there is variation in peak position of a comparatively unfocused image. A peak position having large variation can be given a low weighting, and if peak values are also low from the beginning the weighting of the evaluated value can be made small.

In this way, for every movement of lens position of the optical system, a difference in peak values of evaluated values for the same window is measured, or a difference in movement amount of average position of peak positions in adjacent windows is measured, or both, to thus measure reliability for evaluated values for that window, and it is possible to increase reliability. As a result, when determining final focus position, in the event that short distance is selected from focus positions for a plurality of regions it is possible to improve reliability of ranging even in cases of hand shake or subject movement.

As described above, even if there is subject blur it is possible to improve focus reliability.

In the above described embodiment, in response to operation to select photographing mode by a photographer, partial focus positions other than the closest are selected and made focus positions with directly as a result of the photographer's operation or automatically as a result of selection of control means according to operation of the photographer, but this is not limiting and it is also possible, for example, to use closest partial focus positions among evaluated values that are made valid, that is, to select a partial focus position having the closest peak value, and to make this position a focus position.

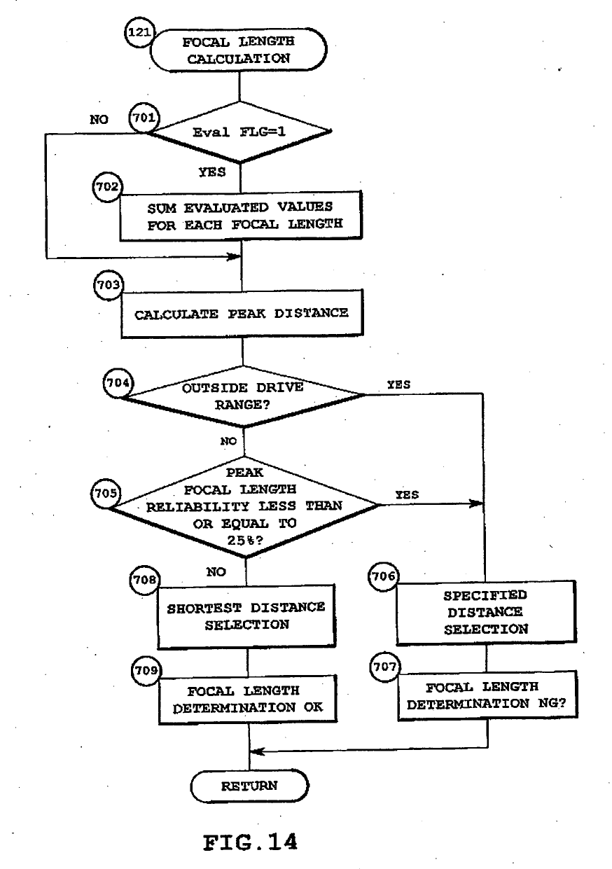

In this case, it is possible to omit photographing mode selection functions for selecting far distance priority mode etc. shown in step 100 of FIG. 7 and FIG. 11, it is possible to change content of focal length calculation (step 121) and to carry out the focus processing calculation shown in FIG. 14 instead of the structure of FIG. 11.

Here, first of all whether or not weight has been added in calculation of the evaluated value is determined from the state of EvalFLG (step 701), and if there is weighting those evaluated values are added for each distance (step 702) while if there is no weighting they are not added.

From these evaluated values, a peak focus position (peak position) is obtained (step 703).

Then, if these peak focus positions are all outside of a set photographing distance range (step 704), or reliability of all peak focus positions is less than or equal to a specified value, for example less than or equal to 25% (step 705) it is determined that subject distance calculation is impossible, and a predetermined specified distance is forcibly set as focus position (focal point position) (step 706).

At this time it is determined that focal length determination is NG (step 707). Also, in cases other than those described above, namely when there is at least one peak focus position (peak position) in a set photographing range, and peak focus position within the set photographing range has a reliability greater than a specified value, for example larger than 25% (step 705), it is determined that calculation of subject distance is possible, a partial focal position having the closest peak position is selected from within valid windows W1-W9, and this position is made a focus position (step 708). At this time it is determined that focal length determination is OK (step 709).

Then, depending on the results of focal length determination (step 707, 709) obtained from this type of focal length calculation (step 121), as shown in FIG. 7 determination of whether focal length determination is OK or NG is carried out (step 122), and if it is OK a peak distance as a calculated image capture focal length is made a focus position and the lens of the optical system 11 is moved (step 123) while if it is NG the lens of the optical system 11 is moved to a specified distance 1 or specified distance 2 that are specified focus positions that have been set in advance (step 124), and in this way it is possible to arrange the lens at the final focus position.

With each of the above described embodiments, description has been with respect to a structure corresponding to movement of a subject T in a horizontal direction, in addition to this structure, or as well as this structure, it is also possible to have movement in the vertical direction or diagonal direction.

Also, the image processing circuit 15 shown in FIG. 1 and FIG. 2 can be formed from the same chip as another circuit, or can be realized in software running on the CPU 17, and it is possible to reduce manufacturing cost by simplifying these structures. The filter circuits of the image processing circuit 15 can have any structure as long as they can detect contrast.

The ranging method is not limited to the so-called hill-climbing method, and it is possible to completely scan a movable ranged of an automatic focusing device.

Also, after applying the weighting process shown in FIG. 9 to the evaluated values for each window, it is also possible to sum up a plurality of adjacent windows, or to carry out the weighting processing after summing up evaluated values for a selected plurality of windows.

Also, in the processing shown in FIG. 7 and FIG. 10, a peak value average position movement amount PTH value and a determination value VTH are subjected to a single setting in advance, but it is also possible to select from a plurality of settings, and may vary according to the size of the evaluated values, or photographing conditions such as information of the optical system 11, such as brightness information, shutter speed, focus magnification etc., an optimum value can be selected, or it is possible to carry out evaluation for a scene by performing calculation with these conditions as variables and obtaining an optimum value.

When taking a picture using a strobe, the strobe emits light in synchronism with image capture for focus processing, and by acquiring image data for each scene it is possible to detect focal length using the above described focal length detecting method. With a structure using a strobe, light emission of the strobe is controlled in response to focal length, and it is possible to take pictures based on light amount control such as camera aperture and shutter speed.

In the above described embodiments, in the event that focal length detection is NG (step 122), the lens of the optical system 11 is moved to a predetermined specified focus position (step 124), but it is also possible to set a plurality of specified focus positions in advance, and move the lens of the optical system 11 to any of the specified focus positions in response to the photographer's intentions, namely in response to operation to select photographing mode.

With the above described embodiments, the structure is such that either of photographing distance range and far distance priority mode can be set by a photographer, but it is also possible to have a structure where only either one can be set, and it is possible simplify the structure and operation.

In suppression of moire, as well automatically carrying out processing it is also possible to reflect the photographer's intentions by making it possible to switch whether control is executed or not manually.

In detection of presence or absence of moire (FIG. 12 and step 601), the CPU 17 analyzes spatial frequency distribution for color difference components in a screen vertical direction using a method such as fast Fourier transform (FFT), and if it is confirmed that there is a component distribution of a specified amount or more in comparatively high frequency color difference components it is possible to determine that there is a danger of moire occurring.

The present invention is applicable to an image capture device such as a digital camera or a video camera.

What is claimed is:

1. An image capture focal length detecting method, comprising the steps of:
acquiring a plurality of image data while changing focal length of an optical system;
acquiring, from the acquired plurality of image data, high frequency component evaluated values, being contrast evaluated values of respective high frequencies, and low frequency component evaluated values, being contrast evaluated values of low frequency components of a frequency lower than the high frequency;
calculating a first focal length using whichever image data a peak value of the high frequency component evaluated values is recorded in;
detecting whether or not there is a moiré in image data of this first focal length;
making the first focal length an image capture focal length if there is no moiré in the image data of the first focal length; and
when there is moiré in the image data of the first focal length, comparing reference evaluated values corresponding to a length based on the low frequency component evaluated values with evaluated values corresponding to a length based on the high frequency component evaluated values, and selecting an image capture focal length in a range where this evaluated value takes a value that is less than or equal to the reference evaluated value.

2. The image capture focal length detecting method of claim 1, wherein calculation of reference evaluation values involves calculation of a proportion of low frequency component evaluated values and high frequency component evaluated values for each image data, for the case when a peak value of low frequency component evaluated values and a peak value of high frequency component evaluated values coincide, and also calculation using a calculation to relatively subtract low frequency component evaluated values from high frequency component evaluated values.

3. The image capture focal length detecting method of claim 2, wherein low frequency component evaluated values are relatively subtracted to calculate reference evaluated values, in response to a specified value, being a variable, according to image capture conditions.

4. The image capture focal length detecting method of claim 3, wherein the specified value is set larger as the depth of field becomes larger.

5. The image capture focal length detecting method of claim 1, wherein any focal length where an evaluated value based on a high frequency component evaluated value matches a reference evaluated value is selected as an image capture focal length depending on image capture mode.

6. The image capture focal length detecting method of claim 1, wherein whether or not a moiré exists is detected utilizing variation in high frequency component evaluated values and low frequency component evaluated values in a plurality of image data that have been acquired while varying focal length of an optical system.

7. The image capture focal length detecting method of claim 1, further comprising the steps of:
setting a plurality of image detection regions adjacent to one another;
calculating, from a plurality of acquired image data, a partial focal length using whichever image data a peak value of respective contrast evaluated values is recorded in, for every image detection region, and calculating a reliability according to movement of a position where respective peak values are recorded between the plurality of image data; and
in response to the reliability and the evaluated values, selecting a first focal length from among the partial focal lengths and a specified focal length.

8. An image capture device, comprising:
an imaging element;
an optical system for causing an image of a subject to be formed on this imaging element;
optical system drive means for varying a focal length of the optical system; and
image processing means for processing image data output from the imaging element and controlling the optical system drive means, wherein
the image processing means controls the optical system drive means;
acquires a plurality of image data while changing focal length of the optical system;
acquires, from the acquired plurality of image data, high frequency component evaluated values, being contrast evaluated values of respective high frequencies, and low frequency component evaluated values, being contrast evaluated values of low frequency components of a frequency lower than the high frequency;
calculates a first focal length using whichever image data a peak value of the high frequency component evaluated values is recorded in;
detects whether or not there is a moiré in image data of this first focal length;
makes the first focal length an image capture focal length if there is no moiré in the image data of the first focal length; and
when there is moiré in the image data of the first focal length, compares reference evaluated values corresponding to a length based on the low frequency component evaluated values with evaluated values corresponding to a length based on the high frequency component evaluated values, and selects an image capture focal length in a range where this evaluated value takes a value that is less than or equal to the reference evaluated value; and
controls the optical system drive means to set focal length of the optical system to the image capture focal length.
